(19) United States
(12) Patent Application Publication
(10) Pub. No.: US 2025/0333984 A1
(43) Pub. Date: Oct. 30, 2025

(54) MOTOR VEHICLE LOCK

(71) Applicant: Brose Schliesssysteme GmbH & Co. Kommanditgesellschaft, Wuppertal (DE)

(72) Inventors: Markus Zillert, Duesseldorf (DE); Ludger Graute, Essen (DE); Rainer Cullmann, Velbert (DE)

(21) Appl. No.: 19/175,361

(22) Filed: Apr. 10, 2025

(30) Foreign Application Priority Data
Apr. 10, 2024 (DE) 10 2024 109 985.2

(51) Int. Cl. E05B 77/02; E05B 79/04

(52) U.S. Cl. CPC E05B 77/02; E05B 79/04

(57) ABSTRACT

Motor vehicle lock having a locking mechanism unit and a functional unit and, in the fastened state, being connected to a bodywork component, the locking mechanism unit having a locking mechanism connection plate in a locking mechanism connection plane and the functional unit having a functional connection plate in a functional connection plane for the purpose of connection to the bodywork component, the motor vehicle lock being L-shaped. The locking mechanism connection plate and the functional connection plate can be configured as separate components and are coupled to one another in such a way that said coupling allows, on the one hand, the transmission of a tearing force in the functional connection plane by way of a form fit between the locking mechanism connection plate and the functional connection plate and, on the other hand, a compensating movement between the locking mechanism connection plate and the functional connection plate.

### Cross-Reference to Related Applications

This application claims the benefit of German Patent application No. DE 10 2024 109 985.2 filed on Apr. 10, 2024, the disclosure of which is incorporated herein by reference in its entirety.

### FIELD OF THE TECHNOLOGY

Various embodiments provide a motor vehicle lock and to a bodywork assembly.

### BACKGROUND

The known motor vehicle lock (DE 10 2015 105 409 A1) comprises a locking mechanism unit having the closing elements “lock catch” and “pawl”. The locking mechanism unit is assigned what is referred to as a catch bearing, which provides an inlet opening for a striker or the like. The lock catch projects into said inlet opening such that it can engage with the striker or the like. Furthermore, said motor vehicle lock comprises a functional unit that provides a lock mechanism. This lock mechanism allows, inter alia, the closing states “locked” and “unlocked” to be generated. The motor vehicle lock disclosed in DE 10 2015 105 409 A1 is also L-shaped, with the locking mechanism unit forming a locking mechanism connection plane and the functional unit forming a functional connection plane. In this case, a locking mechanism connection plate is arranged in the locking mechanism connection plane and can be used to fasten the motor vehicle lock to a bodywork component transversely to the locking mechanism connection plane. Motor vehicle locks of this type are known in which the functional unit, in the functional connection plane, has a functional connection plate for fastening the motor vehicle lock to a bodywork component, such as a motor vehicle door, said functional connection plate being formed by an angled portion of the locking mechanism connection plate.

### SUMMARY

The structural design of the known motor vehicle lock guarantees in principle a secure fastening of the motor vehicle lock to a bodywork component. A challenge here is that the motor vehicle lock must withstand crash-induced tearing forces in the functional connection plane, which can be achieved, inter alia, by a correspondingly solid configuration of the locking mechanism connection plate. Due to the solid configuration, however, it is difficult, during fastening, to compensate for manufacturing tolerances transverse to the functional connection plane between the motor vehicle lock and/or bodywork component to which the motor vehicle lock is to be fastened. As a result of these manufacturing tolerances, it may not be possible to fasten the motor vehicle lock with a substantially uniform contact pressure over the corresponding contact surface or the corresponding contact surfaces between the motor vehicle lock and bodywork component, which results in stresses and/or leaks.

Various embodiments are consequently based on the problem of configuring and developing the known motor vehicle lock in such a way that, in comparison with the prior art, it is insensitive to manufacturing tolerances without impairing the crash safety.

The above problem is solved by various features provided herein.

The motor vehicle lock in question can be used in all types of bodywork components of a motor vehicle. These include in particular side doors, rear doors, tailgates, rear covers or engine hoods. Said bodywork components may in principle also be configured in the manner of sliding doors. The bodywork component and the motor vehicle lock arranged thereon complement one another in the present case to form a bodywork assembly.

What can be essential in some embodiments is the consideration that the configuration of the locking mechanism connection plate and the functional connection plate as separate components enables tolerance compensation without impairing the crash safety if these separate components interact with one another by way of a special coupling. In the event of a crash, this coupling ensures a form fit between the separate components for the purpose of transmitting tearing forces in the functional connection plane and, moreover, this coupling allows a compensating movement for tolerance compensation. Such a compensating movement allows the position of the locking mechanism connection plate and the functional connection plate relative to one another to be adjusted with regard to any geometric tolerances in the bodywork component, such that a uniform contact pressure over the locking mechanism connection plate and the functional connection plate can be generated in a simple manner.

The proposed coupling thus makes it possible to configure the locking mechanism connection plate and the functional connection plate as solidly as required and at the same time to ensure effective tolerance compensation.

The term “tearing force” in the present case combines all those forces that act between the locking mechanism connection plate and the functional connection plate in the fastened state and are attributable to a deformation of the bodywork component.

It is proposed that the form fit between the locking mechanism connection plate and the functional connection plate may already be present when there is not yet any tearing force acting in the functional connection plane between the locking mechanism connection plate and the functional connection plate. It is also possible for the form fit between the locking mechanism connection plate and the functional connection plate to form only when a tearing force is acting in the functional connection plane between the locking mechanism connection plate and the functional connection plate.

Specifically, it is proposed that the locking mechanism connection plate and the functional connection plate are configured as separate components and are coupled to one another in such a way that said coupling allows, on the one hand, the transmission of a tearing force in the functional connection plane by way of a form fit between the locking mechanism connection plate and the functional connection plate and, on the other hand, a compensating movement between the locking mechanism connection plate and the functional connection plate.

The force-locking fastening as provided in some embodiments can be advantageous in particular in the case of an interposed lock seal in order to provide a secure sealing effect. As mentioned above, the proposed compensating movement guarantees a uniform contact pressure on the lock seal. This is regardless of any manufacturing tolerances.

Designing the coupling to withstand the tearing forces, in some embodiments, ensures that the motor vehicle lock installed in a motor vehicle remains functional during operation, even in the event of a crash and a tearing force thus acting on the lock in the functional connection plane. This means that the motor vehicle door can be opened at any time during the operation of the motor vehicle. However, it remains closed during an accident, which increases the safety of the occupants.

Various embodiments take into account the fact that manufacturing tolerances on the locking mechanism connection plate have a considerable influence primarily transversely to the functional connection plane. As mentioned above, these manufacturing tolerances can lead to the motor vehicle lock having different contact pressures at the contact surfaces between the motor vehicle lock and the bodywork component after fastening, which causes stresses to build up in the motor vehicle lock and/or the bodywork component. The stresses can shorten the service life of the motor vehicle lock and/or lead to a lack of functional reliability. The compensating movement makes it possible to avoid in particular different contact pressures, with the result that the motor vehicle lock can be fastened to the bodywork component at the same time fixedly and with a substantially uniform contact pressure. A lock seal arranged between the motor vehicle lock and the bodywork component is thereby uniformly loaded, which results in said lock seal also having a longer service life and bringing about a longer-lasting and more secure seal. A compensating movement having a movement component transverse to the functional connection plane can be provided.

Various embodiments provide the compensating movement at least also as a pivoting movement between the locking mechanism connection plate and the functional connection plate, as a result of which an angle compensation between the functional plane and the bodywork component arranged parallel thereto is possible. The resulting pivotably movable connection of the locking mechanism connection plate and the functional connection plate is structurally particularly easy to implement.

The interlocking of the locking mechanism connection plate and the functional connection plate as provided in some embodiments is a particularly simple type of the proposed coupling, which is also releasable. In addition, the assembly of the motor vehicle lock can be carried out very easily with regard to the coupling between the locking mechanism connection plate and the functional connection plate, since in the simplest case the two plates merely need to be plugged into one another.

Various embodiments relate to an interlocking, according to which any tearing force acting between the locking mechanism connection plate and the functional connection plate can be transmitted by way of the interlocking. This coupling can be released at any time if no tearing force is acting on the functional connection plate in the functional connection plane. At the same time, a secure form fit is ensured when there is loading in the functional connection plane.

Various embodiments relate to a variant of the interlocking, which is based on the fact that a first projection on one of the connection plates engages in a cutout of the other connection plate. Such an interlocking results in a stable coupling of the plates in the functional connection plane with, simultaneously, a simple design and simple assembly of the coupling.

Various embodiments relate to a connection of the functional connection plate to the functional unit, as a result of which the functional connection plate is held on the functional unit. This makes it possible in principle for a possible mounting thread or the like for fastening the motor vehicle lock to the bodywork component to be arranged on the functional connection plate and not, for example, moreover on the functional unit.

According to various embodiments, the functional connection plate is arranged separately and predominantly outside the locking mechanism connection plate. As a result, the dimensions of the functional connection plate can be determined independently of the locking mechanism connection plate, since merely a correspondingly configured coupling between the functional connection plate and the locking mechanism connection plate must be able to be realized. The length and/or width, or shape, of the functional connection plate can thus be designed individually, for example for different product series.

According to various embodiments, a bodywork assembly having a bodywork component that, in the assembled state, is adjustable between a closed position and an open position and having a proposed motor vehicle lock is provided.

Reference may be made to all the statements regarding the proposed motor vehicle lock.

Various embodiments provide a motor vehicle lock comprising a locking mechanism unit and a functional unit and, in the fastened state, being connected to a bodywork component, in particular a motor vehicle door, the locking mechanism unit having a locking mechanism connection plate in a locking mechanism connection plane and the functional unit having a functional connection plate in a functional connection plane for the purpose of connection to the bodywork component, the motor vehicle lock being L-shaped and, for this purpose, the locking mechanism connection plane and the functional connection plane being oriented at an angle to one another, in particular transversely to one another, wherein the locking mechanism connection plate and the functional connection plate are configured as separate components and are coupled to one another in such a way that said coupling allows, on the one hand, the transmission of a tearing force in the functional connection plane by way of a form fit between the locking mechanism connection plate and the functional connection plate and, on the other hand, a compensating movement between the locking mechanism connection plate and the functional connection plate.

In various embodiments, in the fastened state, the motor vehicle lock is fastened to the bodywork component using the locking mechanism connection plate and/or using the functional connection plate in a force-locking manner, such as by way of a lock seal. In some embodiments, the functional connection plate and/or the locking mechanism connection plate has/have for this purpose at least one screw-connection point.

In various embodiments, the form fit between the locking mechanism connection plate and the functional connection plate is configured in such a way that it withstands a tearing force in the functional connection plane, said tearing force being in a range of between 4 kN and 12 kN, such as being 6 kN.

In various embodiments, the compensating movement between the locking mechanism connection plate and the functional connection plate has a movement component transverse to the functional connection plane.

In various embodiments, the compensating movement comprises a pivoting movement between the locking mechanism connection plate and the functional connection plate, such as a pivoting movement about the coupling point between the locking mechanism connection plate and the functional connection plate.

In various embodiments, the coupling between the locking mechanism connection plate and the functional connection plate is attributable to an interlocking of the locking mechanism connection plate with the functional connection plate.

In various embodiments, the locking mechanism connection plate and the functional connection plate are interlocked in such a way that any tearing force acting between the locking mechanism connection plate and the functional connection plate can be transmitted by way of the interlocking.

In various embodiments, the interlocking is provided by way of a first projection of the locking mechanism connection plate or of the functional connection plate, which projection projects into a first cutout of the functional connection plate or of the locking mechanism connection plate. In some embodiments, the first projection protrudes from the locking mechanism connection plate or the functional connection plate, and, in some embodiments, can be bent away therefrom, and/or wherein the cutout is in the functional connection plane.

In various embodiments, the functional connection plate, in particular in the region of its at least one screw-connection point, is moreover connected to the functional unit, such as to a functional housing.

In various embodiments, the functional connection plate is arranged separately and predominantly outside the locking mechanism connection plate.

Various embodiments provide a bodywork assembly having a bodywork component that, in the assembled state, can be adjusted between a closed position and an open position and having a motor vehicle lock arranged on the bodywork component, wherein the motor vehicle lock is configured as provided herein.

In various embodiments, the bodywork component is a closure element of a motor vehicle, in particular a motor vehicle door or a motor vehicle flap.

### BRIEF DESCRIPTION OF THE DRAWINGS

Various aspects are explained in more detail below with reference to a drawing merely illustrating an exemplary embodiment. In the drawing:

FIG. 1 shows a proposed bodywork assembly having a proposed motor vehicle lock in a perspective illustration and in two sectional illustrations, and

FIG. 2 shows the motor vehicle lock according to FIG. 1 in an exploded illustration.

### DETAILED DESCRIPTION

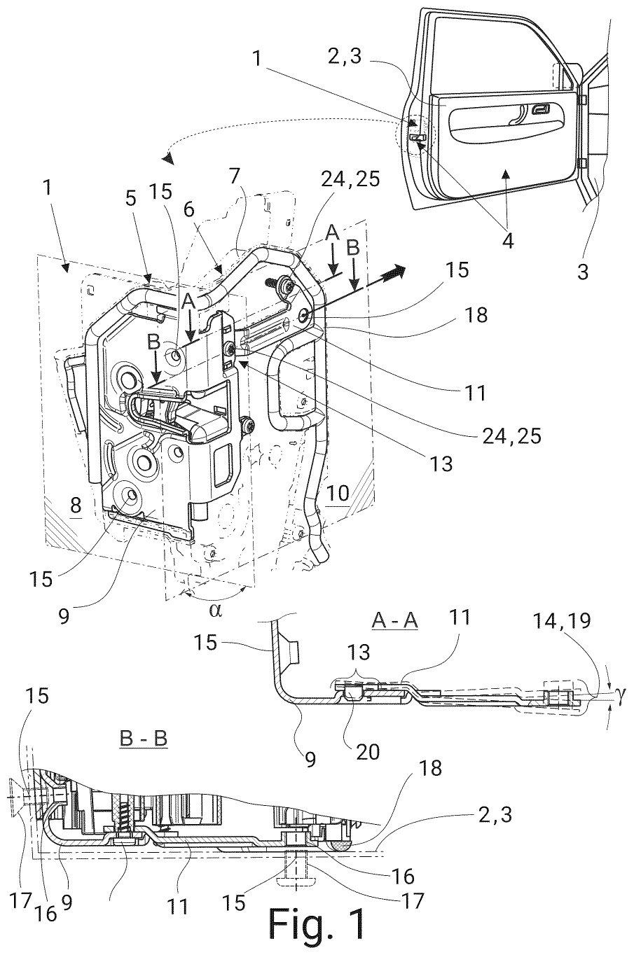

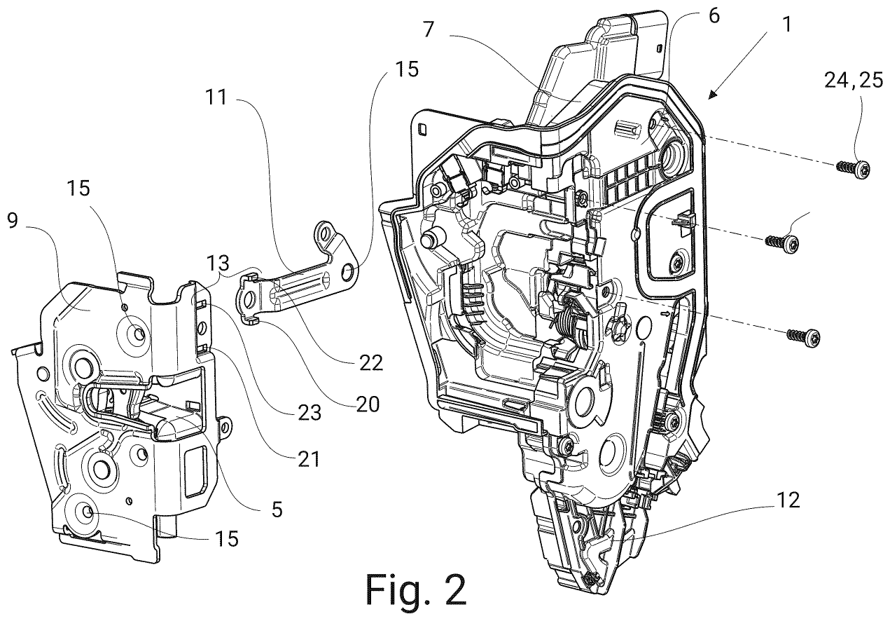

The motor vehicle lock 1 shown in FIGS. 1 and 2 may, as shown in FIG. 1, be assigned to a motor vehicle door 2, or any bodywork component 3 that is not shown, of a motor vehicle. Examples of such a bodywork component 3 were given in the introductory part of the description. The bodywork component 3 and the motor vehicle lock 1 arranged thereon complement one another to form a bodywork assembly 4.

The illustrated motor vehicle lock 1 is equipped with a locking mechanism unit 5 and a functional unit 6. The locking mechanism unit 5 serves, in some embodiments, for receiving the closing elements lock catch and pawl. It is provided in this case that the lock catch can be brought into a closed position in which it is held by the pawl and in which it interacts in the customary manner with a striker or the like. The pawl may in principle be part of a multi-pawl system.

The functional unit 6 serves to implement various lock functions, in particular to implement various closing states such as “locked” and “unlocked”. It can have a functional housing 7, which serves to receive and/or cover at least one functional element. The functional element can be any type of lever, actuator, drive or the like.

In the fastened state, the motor vehicle lock 1 is connected to a bodywork component 3, in particular a motor vehicle door 2. The locking mechanism unit 5 has a locking mechanism connection plate 9 in a locking mechanism connection plane 8 and the functional unit 6 has a functional connection plate 11 in a functional connection plane 10 for the purpose of connection to the bodywork component 3, for example in the form of a motor vehicle door 2. The locking mechanism connection plate 9 serves to fasten the motor vehicle lock 1 to a bodywork component 3, for example to a motor vehicle door 2, transversely to the locking mechanism connection plane 8. The functional connection plate 11 is provided for fastening the motor vehicle lock 1 to a bodywork component 3, in the present case in FIG. 1 a motor vehicle door 2, transversely to the functional connection plane 10.

The motor vehicle lock 1 is L-shaped. For this purpose, the locking mechanism connection plane 8 and the functional connection plane 10 are oriented at an angle to one another, in particular transversely to one another. In some embodiments, the two connection planes together enclose an angle α, which is approximately 90° transverse. For other applications, the angle a can be in a range of between 80° and 130°. Especially in the application of the motor vehicle lock 1 for sliding doors, an angle α of 120° can be provided.

The motor vehicle lock 1 further has a cover 12, which covers at least a part of the functional housing 7, with the cover 12 in principle also being able to receive the abovementioned functional elements.

It is then essential that the locking mechanism connection plate 9 and the functional connection plate 11 are configured as separate components. Separate means that the locking mechanism connection plate 9 and the functional connection plate 11 are present at least in two parts and are coupled to one another by way of the coupling 13. Both locking mechanism connection plate 9 and functional connection plate 11 can be manufactured as stamped/bent parts.

The locking mechanism connection plate 9 and the functional connection plate 11 are coupled to one another in such a way that said coupling 13 allows the transmission of a tearing force in the functional connection plane 10 by way of a form fit between the locking mechanism connection plate 9 and the functional connection plate 11. As shown in FIG. 2, the coupling 13 comprises the area on which the locking mechanism connection plate 9 is arranged relative to the functional connection plate 11 and possibly comes into contact therewith. Depending on the direction vector, the tearing force can act in a pulling or pushing manner on the coupling 13, such that a tearing force acting on the functional connection plate 11 is transmitted to the locking mechanism connection plate 9 in a pulling or pushing manner by way of the coupling 13.

The coupling 13 between the locking mechanism connection plate 9 and the functional connection plate 11 is in this case also configured in such a way that it allows a compensating movement 14 between the locking mechanism connection plate 9 and the functional connection plate 11, which means that the functional connection plate 11 is movable relative to the locking mechanism connection plate 9. The compensating movement 14 that is possible due to this movability can be any movement between the locking mechanism connection plate 9 and the functional connection plate 11. It is for example a rotational movement about an axis along or transverse to the functional connection plane 10 and/or a translational movement in the locking mechanism connection plane 8 and/or in the functional connection plane 10 and/or transverse to the functional connection plane 10.

In some embodiments, in the fastened state, the motor vehicle lock 1 is fastened to the bodywork component 3 using the locking mechanism connection plate 9 and/or using the functional connection plate 11 in a force-locking manner. For this purpose, at least one screw-connection point 15, in particular in the form of a mounting thread 16 for a mounting screw 17, can be provided on the locking mechanism connection plate 9 and/or on the functional connection plate 11, which screw-connection point allows a force-locking and releasable fastening of the motor vehicle lock 1 to a bodywork component 3 by means of a screw.

In the fastened state, the motor vehicle lock 1 is fastened to the bodywork component 3 using the locking mechanism connection plate 9 and/or using the functional connection plate 11, such as by way of a dedicated lock seal 18. Such a lock seal 18 is well known to a person skilled in the art. This may be any element that can be arranged between the motor vehicle lock 1 and the bodywork component 3 and is suitable for protecting the motor vehicle lock 1 at least partially from influences from the surrounding area outside the motor vehicle lock 1, in particular from moisture and dust, after it has been fastened to the bodywork component 3. In some embodiments, it is an elastic material that is arranged between the motor vehicle lock 1 and the bodywork component 3. In some embodiments, as shown in FIG. 1, the lock seal 18 is arranged on the motor vehicle lock 1 itself. Specifically, the lock seal 18 here is arranged completely or partially on the locking mechanism connection plate 9 and/or functional connection plate 11. It is also possible for the lock seal 18 to be arranged on the motor vehicle lock 1 outside the locking mechanism connection plate 9 and/or functional connection plate 11. Before the motor vehicle lock 1 is fastened, the lock seal 18 may in principle, however, also be applied to a surface of the bodywork component 3 to which the motor vehicle lock 1 is to be fastened in such a way that, after the motor vehicle lock 1 has been fastened in a force-locking manner, the lock seal 18 is arranged between the motor vehicle lock 1 and the bodywork component 3 and can perform its sealing function. The lock seal 18 can also be fitted between the motor vehicle lock 1 and the bodywork component 3 during the fastening in such a way that the lock seal 18 only comes into contact with the motor vehicle lock 1 and protects the latter from weathering influences once the motor vehicle lock 1 has been fastened to the bodywork component 3 in a force-locking manner.

It can be further provided that the form fit between the locking mechanism connection plate 9 and the functional connection plate 11 is configured in such a way that it withstands a tearing force in the functional connection plane 10 in the event of a crash, said tearing force being in a range of between 4 kN and 12 kN, such as being 6 kN. Here, the resolution of the apparent contradiction between, one the one hand, a high resistance of a connection plate and simultaneous movability becomes evident. Only as a result of the proposed combination of locking mechanism connection plate 9, coupling 13 and functional connection plate 11 is it possible to withstand such a high tearing force and at the same time enable a tolerance compensation.

The compensating movement 14, during the fastening of the lock, between the locking mechanism connection plate 9 and the functional connection plate 11 can have a movement component transverse to the functional connection plane 10. The direction specification “transverse to a plane” in this case applies to any vector that has a component orthogonal to the corresponding plane. Accordingly, the movement component transverse to the functional connection plane 10 is orthogonal to the functional connection plane 10.

The compensating movement 14 can include a pivoting movement 19 between the locking mechanism connection plate 9 and the functional connection plate 11. As shown in the sectional view of the coupling 13 between the locking mechanism connection plate 9 and the functional connection plate 11 in FIG. 1, such a pivoting movement 19 can be a change of the angle γ enclosed between the locking mechanism connection plate 9 and the functional connection plate 11 transverse to the functional connection plane 10. In other embodiments not shown here, however, a pivoting movement 19 may additionally or completely have a direction component transverse to the locking mechanism connection plane 8. In various embodiments, the compensating movement 14 is a pivoting movement 19 about the coupling point between the locking mechanism connection plate 9 and the functional connection plate 11.

The sectional view B-B of FIG. 1 shows a motor vehicle lock 1, which is fastened to the bodywork component 3 in a force-locking manner by way of the screw-connection points 15 and the mounting screws 17 (not fully screwed in in the illustration) that are screwed into the mounting threads 16. By virtue of the fact that it is proposed for an above compensating movement 14 to be provided, the locking mechanism connection plate 9 and the functional connection plate 11 can adapt to any imprecisions in the bodywork component 3. This allows for a substantially uniform contact pressure over the contact surfaces to be achieved in a simple manner. Within the meaning of the application, “contact surface” refers to any surface of the motor vehicle lock 1 that comes into contact with an element not assigned to the motor vehicle lock 1 when the motor vehicle lock 1 is fastened to a bodywork component 3. Said element can be the abovementioned lock seal 18.

Furthermore, it can be provided, as shown in sectional view A-A of FIG. 1, that the coupling 13 between the locking mechanism connection plate 9 and the functional connection plate 11 is attributable to an interlocking of the locking mechanism connection plate 9 with the functional connection plate 11. Within the meaning of the application, an interlocking means that the locking mechanism connection plate 9 and the functional connection plate 11 form a force-locking form fit through a contour of the other plate. Thus, for example, a contour of the locking mechanism connection plate 9 engages in an oppositely formed contour of the functional connection plate 11, such that, when a tensile force is applied in the functional connection plane 10, the locking mechanism connection plate 9 is immovable in the direction of the tensile force due to a form fit with respect to the functional connection plate 11. Analogously thereto, for example, a contour of the functional connection plate 11 engages in an oppositely formed contour of the locking mechanism connection plate 9, such that, when a tensile force is applied in the functional connection plane 10, the functional connection plate 11 is immovable in the direction of the tensile force due to a form fit with respect to the locking mechanism connection plate 9.

In various embodiments, the locking mechanism connection plate 9 and the functional connection plate 11 are interlocked in such a way that any tearing force acting between the locking mechanism connection plate 9 and the functional connection plate 11 can be transmitted by way of the interlocking. In this way, the interlocking can be designed such that the form fit is formed at least when a tearing force is acting between the locking mechanism connection plate 9 and the functional connection plate 11. It should be emphasized that the interlocking can be designed in such a way that it allows the transmission of an abovementioned crash-induced tearing force in the functional connection plane 10.

In particular, the interlocking can be provided by way of a first projection 20 of the locking mechanism connection plate 9 or of the functional connection plate 11, which projection projects into a first cutout 21 of the functional connection plate 11 or of the locking mechanism connection plate 9. In general, a projection in this case is any elevation that starts from a base surface in the region of the coupling 13 and projects from the functional connection plate 11 and/or locking mechanism connection plate 9 transversely to the functional connection plane 10 and/or transversely to the locking mechanism connection plane 8. The base surface of the elevation here can have any shape, such as being round or polygonal. The projection may be, for example but not exclusively, a lug, a rod or a tab. Further projections, as illustrated for example in FIG. 2 in the form of a second projection 22, may also be present in addition to the first projection 20.

Generally, a cutout within the meaning of the application is any indentation of the functional connection plate 11 and/or of the locking mechanism connection plate 9 in the region of the coupling 13 into a surface transverse to the functional connection plane 10 and/or transverse to the locking mechanism connection plane 8, e.g. in the form of an opening, into which a projection of the respective other functional connection plate 11 and/or locking mechanism connection plate 9 can project in order to enable a form fit between functional connection plane 10 and locking mechanism connection plane 8. For the sake of clarity, it should be noted that further cutouts, as illustrated for example in FIG. 2, may also be present in the form of a second cutout 23 in addition to the first cutout 21. Here, the cutout is arranged on the respective connection plate in such a way that the projection of the respective other connection plate can engage in this recess in a form-fitting manner when a tensile force is acting in the direction of the functional connection plane 10. This is to be clarified by reference to FIG. 2. According to this figure, the first projection 20 of the functional connection plate 11 is designed in such a way that it can engage in the first cutout 21 of the locking mechanism connection plate 9. Analogously thereto, the second projection 22 of the functional connection plate 11 is designed in such a way that it can engage in the second cutout 23 of the locking mechanism connection plate 9. If a tensile force, in particular a tearing force, is brought about along the functional connection plane 10 when the first projection 20 engages in the first cutout 21 and the second projection 22 engages in the second cutout 23, the first projection 20 interlocks with the first cutout 21 and the second projection 22 interlocks with the second cutout 23 (see FIG. 1) in an interlocking direction predefined in accordance with the direction vector of the tensile force, or tearing force. In various embodiments, the cutout is in the form of a negative of the projection. In addition, but not shown, the first projection 20 of one of the connection plates may have a second transverse projection transverse to the first interlocking direction or an undercut, with which the respective other connection plate can interlock transversely to the first interlocking direction. This prevents the release of the interlocking transverse to the interlocking direction and therefore brings about a more stable coupling 13.

It can be further provided here that the functional connection plate 11 is moreover connected to the functional unit 6, in particular to the functional housing 7. The effect of the functional connection plate 11 being connected to the functional unit 6 is that a counterforce to the force fit can be established over the contact surfaces in the direction of the bodywork component 3 by the functional connection plate 11, such that a force-locking fastening of the entire motor vehicle lock 1 to the bodywork component 3 transverse to the functional connection plane 10 is enabled. As shown in FIG. 1, this fastening is realized by means of fastening elements 24 in the form of fastening screws 25, which are screwed into the functional housing 7.

In various embodiments, the connection of the functional connection plate 11 moreover to the functional unit 6 is carried out in the region of the at least one screw-connection point 15 of the functional connection plate 11. This results in a particularly robust connection, since lever forces resulting from a lever, formed by the distance between the screw-connection point 15 and the corresponding location of the connection of the functional connection plate 11 moreover to the functional unit 6 (in FIG. 1 by the fastening screw 25), are reduced.

It can be further provided that the functional connection plate 11 is arranged separately and predominantly outside the locking mechanism connection plate 9. Predominantly means that the surface of the functional connection plate 11 in functional connection plane 10 is to a large extent outside the area covered by the locking mechanism connection plate 9 in locking mechanism connection plane 8. For instance, in some embodiments, less than 30% or less than 10% of the area covered by the functional connection plate 11 is located within the area covered by the locking mechanism connection plate 9.

A bodywork assembly 4 having a bodywork component 3 that, in the assembled state, can be adjusted between a closed position and an open position is also proposed. It is essential that the bodywork assembly 4 has a motor vehicle lock 1. Reference may be made to all the statements regarding the proposed motor vehicle lock 1.

1. A motor vehicle lock comprising a locking mechanism unit and a functional unit and, in the fastened state, being connected to a bodywork component, the locking mechanism unit comprising a locking mechanism connection plate in a locking mechanism connection plane and the functional unit comprising a functional connection plate in a functional connection plane for the purpose of connection to the bodywork component, the motor vehicle lock being L-shaped and, for this purpose, the locking mechanism connection plane and the functional connection plane being oriented at an angle to one another,
wherein the locking mechanism connection plate and the functional connection plate are configured as separate components and are coupled to one another in such a way that said coupling allows, on the one hand, the transmission of a tearing force in the functional connection plane by way of a form fit between the locking mechanism connection plate and the functional connection plate and, on the other hand, a compensating movement between the locking mechanism connection plate and the functional connection plate.

2. The motor vehicle lock as claimed in claim 1, wherein, in the fastened state, the motor vehicle lock is fastened to the bodywork component using the locking mechanism connection plate and/or using the functional connection plate in a force-locking manner.

3. The motor vehicle lock as claimed in claim 1, wherein the form fit between the locking mechanism connection plate and the functional connection plate is configured in such a way that it withstands a tearing force in the functional connection plane, said tearing force being in a range of between 4 kN and 12 kN.

4. The motor vehicle lock as claimed in claim 1, wherein the compensating movement between the locking mechanism connection plate and the functional connection plate has a movement component transverse to the functional connection plane.

5. The motor vehicle lock as claimed in claim 4, wherein the compensating movement comprises a pivoting movement (19)-between the locking mechanism connection plate and the functional connection plate.

6. The motor vehicle lock as claimed in claim 1, wherein the coupling between the locking mechanism connection plate and the functional connection plate is attributable to an interlocking of the locking mechanism connection plate with the functional connection plate.

7. The motor vehicle lock as claimed in claim 6, wherein the locking mechanism connection plate and the functional connection plate are interlocked in such a way that any tearing force acting between the locking mechanism connection plate and the functional connection plate can be transmitted by way of the interlocking.

8. The motor vehicle lock as claimed in claim 6, wherein the interlocking is provided by way of a first projection of the locking mechanism connection plate or of the functional connection plate, which projection projects into a first cutout of the functional connection plate or of the locking mechanism connection plate.

9. The motor vehicle lock as claimed in claim 1, wherein the functional connection plate is moreover connected to the functional unit.

10. The motor vehicle lock as claimed in claim 1, wherein the functional connection plate is arranged separately and predominantly outside the locking mechanism connection plate.

11. A bodywork assembly having a bodywork component that, in the assembled state, can be adjusted between a closed position and an open position and having a motor vehicle lock arranged on the bodywork component,
wherein the motor vehicle lock is configured as claimed in claim 1.

12. The bodywork assembly as claimed in claim 11, wherein the bodywork component is a closure element of a motor vehicle.

13. The motor vehicle lock as claimed in claim 1, wherein the bodywork component comprises a motor vehicle door.

14. The motor vehicle lock as claimed in claim 1, wherein the locking mechanism connection plane and the functional connection plane being oriented transversely to one another.

15. The motor vehicle lock as claimed in claim 1, wherein, in the fastened state, the motor vehicle lock is fastened to the bodywork component using the locking mechanism connection plate and/or using the functional connection plate in a force-locking manner, by way of a lock seal, wherein the functional connection plate and/or the locking mechanism connection plate has/have for this purpose at least one screw-connection point.

16. The motor vehicle lock as claimed in claim 5, wherein the pivoting movement is about the coupling point between the locking mechanism connection plate and the functional connection plate.

17. The motor vehicle lock as claimed in claim 8, wherein the first projection protrudes from the locking mechanism connection plate or the functional connection plate, and/or wherein the cutout is in the functional connection plane.

18. The motor vehicle lock as claimed in claim 8, wherein the first projection protrudes from the locking mechanism connection plate or the functional connection plate and is bent away therefrom.

19. The motor vehicle lock as claimed in claim 9, wherein the functional unit comprises a functional housing.
